(19) United States
(12) Patent Application Publication
(10) Pub. No.: US 2013/0226680 A1
(43) Pub. Date: Aug. 29, 2013

(54) COMMERCE PLATFORM

(71) Applicant: Nicholas Alexander Gabriel, New Malden (GB)

(72) Inventor: Nicholas Alexander Gabriel, New Malden (GB)

(21) Appl. No.: 13/778,587

(22) Filed: Feb. 27, 2013

(30) Foreign Application Priority Data
Feb. 27, 2012 (GB) 1203347.8

(51) Int. Cl. G06Q 30/00

(52) U.S. Cl. CPC G06Q 30/00
USPC 705/14.14

(57) ABSTRACT

A commerce platform has user, referral tree, purchasing, reward and invitation modules, and allows users to purchase items and allows for a user referral system which incentivises the viral referral of new users. When a user purchases an item the purchasing module automatically transfers a fraction of the purchase value to a reward account. This fraction contributes to an award value. The referral tree module is operable to create and store a plurality of referral trees having one or more user accounts. The reward module is operable to determine a main award account from one of the user accounts of the referral tree and to distribute at least part of the award value between the main award account and one or more additional user accounts. Each additional user account belongs to a reward tree in which the main award account is a secondary user account.

The present invention relates to a commerce platform. In particular, it relates to a commerce platform which is operable to reward users.

Since the invention of the world wide web, internet transactions have become increasingly common. Such transactions take place on an electric commerce platform which allows users to order items and transfer payment in exchange. A commerce platform may allow users to order items directly from a supplier. Alternatively, a third party commerce platform may allow users to browse and order items offered by a plurality of suppliers and compare the attributes and prices of items offered by two or more suppliers.

Since commerce platforms may need to compete with each other for custom, in order for a commerce platform to be successful it requires a mechanism for attracting customers. One such mechanism is advertising. However, traditional advertising may not offer a sufficient incentive for potential customers to use a particular commerce platform in preference to other available commerce platforms.

It is an object of embodiments of the present invention to at least partially address the above problems.

According to a first aspect of the present invention there is provided a commerce platform comprising:
a user module that is operable to create and store a user account for each of a plurality of users of the commerce platform;
a referral tree module that is operable to create and store a plurality of referral trees, wherein each referral tree comprises a primary user account and may additionally comprise one or more secondary user accounts, the referral tree module being operable to: create and store such a user referral tree for each user account, said user account being the primary user account of said the referral tree; and, optionally, to add each user account as a secondary user account of one or more existing referral trees;
a purchasing module that allows each user to purchase one or more items in exchange for a purchase value wherein the purchasing module is further operable, when a user makes such a purchase, to transfer a fraction of the purchase value from that user's user account to a reward account to contribute to an award value; and
a reward module that is operable to determine a main award account from one of the user accounts and to distribute at least part of the award value between:
said main award account and one or more additional user accounts wherein each additional user account belongs to a referral tree in which the main award account is a secondary user account.

Advantageously, such an arrangement offers an incentive to users of the commerce platform by offering the opportunity to win a share of the award value.

Furthermore, it offers a greater chance of receiving a share of the award value to a user account which is the primary user account of a referral tree with a large number of secondary user accounts.

The secondary accounts of a referral tree may correspond to users who have been referred to the commerce platform by the user corresponding to the primary user account of that referral tree. Such referrals may be direct or indirect. Such a system offers an incentive for users to refer new potential users to the commerce platform since the more new users that a first user refers to the commerce platform, the greater the chance that the first user will receive a share of the award value.

The award account may be determined by selecting a user account from a subset of the user accounts. The subset of user accounts may comprise the user accounts which have contributed to the award value. This offers an incentive for users of the commerce platform to purchase items via the commerce platform.

The reward module may comprise a random or pseudo-random number generator. The reward module may determine the main award account randomly or pseudo-randomly. The reward module may determine the main award account democratically so that each member of a subset of user accounts has an equal probability of being selected. Alternatively, the selection of the main award account may be weighted. The weighting may be such that the probability of a user account being selected as the main award is a function of the value that has been transferred from that user account into the reward account. For example, the probability of a user account being selected as the main award account may be proportional to the value that has been transferred from that user account into the reward account. Advantageously, this offers an incentive for users of the commerce platform spend more via the commerce platform.

The referral trees may comprise one or more levels of user accounts. The primary user account of a referral tree may be the top level of that referral tree. The referral trees may comprise one or more levels of secondary user accounts. Said one or more levels of secondary user accounts may be lower than the level of the primary user.

The reward module may distribute the award value so that a first portion is transferred to the main award account. The remainder of the award value may be shared between a subset of the additional user accounts. The subset of additional user accounts may be those user accounts that are only a certain number of levels above the main award account in the referral trees to which they both belong. For example, the subset of additional user accounts may be those user accounts that are fewer than four levels above the main award account. The additional user accounts in each level above the main award account may share a fixed portion of the award value. For example, in one specific embodiment, reward module may distribute the award value so that: a first portion is transferred to the main award account; a second portion is shared by all user accounts that belong to the same referral tree as the main award account and are one level above the main award account; a third portion is shared by all user accounts that belong to the same referral tree as the main award account and are two levels above the main award account; and a fourth portion is shared by all user accounts that belong to the same referral tree as the main award account and are three levels above the main award account.

The commerce platform may comprise an invitation module. The invitation module may be operable to send an invitation to a potential user of the commerce platform. Said invitation module may be sent at the request of an existing user. The invitation may be sent in any convenient form including, for example, an email; a short message service (SMS) message; or a message on a social network. The invitation module may be further operable to store details of all invitations that it sends. Said details may comprise an identifier of an existing user who requested that the message be sent and an identifier of a potential new user to whom it was sent. This allows the commerce platform to determine which new users were referred to the commerce platform and by whom. Said details may be stored in a database. The details may further comprise the time at which a request was made to send the invitation.

When the user module creates a new user account it may be operable to instruct the referral tree module to create and store a new referral tree with the new user account being the primary user account for said new referral tree. Preferably, each user account can only be the primary account of one referral tree.

When the user module creates a new user account it may be operable to check whether or not any invitations have been sent to said user by the invitation module. If any such invitations have been sent, the user module may be operable to: determine one or more referrer accounts that requested that said invitations be sent; and instruct the referral tree module to add the new user account as a secondary user account of any referral trees which comprise those referrer accounts. The new user account may be added to the referral trees which comprise those referrer accounts at the level directly below said referrer accounts. The new user account may be added as a secondary user account of all referral trees which comprise any of said referrer accounts. Alternatively, the new user account may only be added as a secondary user account of all referral trees which comprise a referrer account that made the first request for an invitation to be sent.

The referral tree module may allow a first user account to be added as a secondary user account of any referral trees which comprise a second user account upon request by the first user. The first user account may be added to the referral trees which comprise the second user account at the level directly below the second user account.

When the referral tree module creates or alters a referral tree, the referral tree module may be operable to send a message to all user accounts that form part of that referral tree.

The fraction of the purchase value that is transferred to the reward account may be dependent upon one or more variable. In particular, the fraction may be dependent upon any or all of the following: the item being purchased; the user that is purchasing the item; or the purchase value of the item.

The commerce platform may comprise a plurality of reward accounts. For such embodiments, the purchasing module may be operable to transfer the fraction of the purchase value into one of said reward accounts. Alternatively, the purchasing module may be operable to distribute the fraction of the purchase value between two or more reward accounts.

The reward module may determine a main award account at any suitable time. The reward module may be operable to determine a main award account when an event occurs. Said event may be: when the award value equals or exceeds a finishing value; when a finishing time is reached; or any other suitable event. Once the reward module has determined a main account and distributed the award value, the reward module may be operable to subsequently determine another main account when a second event occurs.

Each user account may comprise a user identifier and a passcode. The user module may comprise an authentication system. The authentication may be operable to check that a correct user identifier and a correct passcode has been provided before allowing a use to log into his/her user account.

The commerce platform may comprise a relationship module. The relationship module may be operable to create relationships between two user accounts. Said relationships may be created upon request by a first user account and a confirmation by a second user account.

The user account may comprise a user profile. The user profile of a user account may comprise information relating to the user of that account. The user profile of a user account may comprise a list of other user accounts which have a relationship with that user account.

The purchasing module may comprise a means for communicating with external third party suppliers. This may allow a user of the commerce platform to purchase an item from said third party suppliers via the commerce platform according to the present invention.

In order that the invention may be more clearly understood an embodiment thereof will now be described, by way of example only, with reference to the accompanying drawings, of which:

FIG. 1 is a schematic illustration of a commerce platform according to the present invention; and

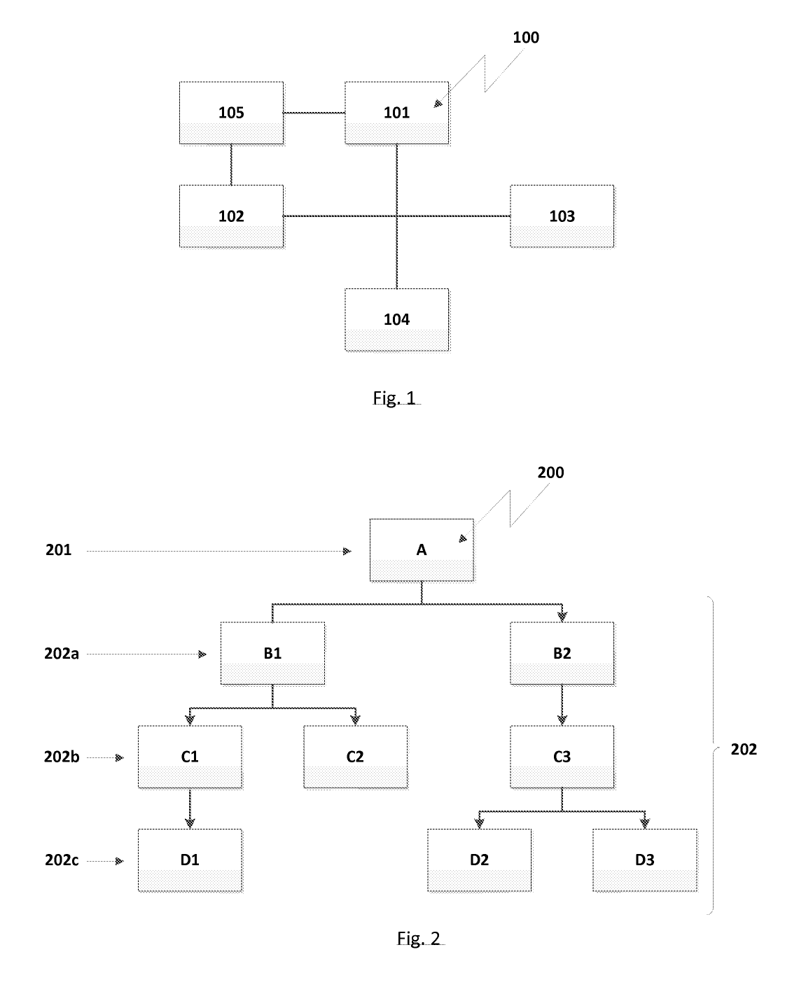

FIGS. 2-6 show examples of referral trees generated by the referral tree module of the present invention.

Referring to FIG. 1, a commerce platform 100 according to the present invention comprises: a user module 101; a referral tree module 102; a purchasing module 103; a reward module 104; and an invitation module 105. The commerce platform 100 allows users to purchase items and allows for a user referral system which incentivises the viral referral of new users.

When a new user joins the commerce platform 100, the user module 101 creates and stores a new user account for that new user. Each user account comprises a user identifier and a user profile comprising information relating to the user of that account. Functionality is provided for users to become friends on the commerce platform 100. This may allow a first user account to send a friend request to a second user account. Subject to a confirmation by the second user account, the users of the first and second user accounts will become friends. The user profile of each user account comprises a list of other users which that user is friends with.

The purchasing module 103 allows each user to purchase one or more items in exchange for a purchase value. When a user of the commerce platform 100 purchases an item the purchasing module 102 automatically transfers a fraction of the purchase value from that user's user account to a reward account. This fraction of the purchase value contributes to an award value. The fraction of the purchase value that is transferred to the reward account may be dependent upon any or all of the following: the item being purchased; the user that is purchasing the item; or the purchase value of the item.

The referral tree module 102 is operable to create and store referral information. The referral tree module 102 is operable to create and store a plurality of referral trees, comprising one or more user accounts. An example of a referral tree 200 created by the referral tree module 102 is shown in FIG. 2. The one or more user accounts are arranged in levels 201, 202 and each referral tree comprises a primary user account 201 that is the top level of that referral tree. Each referral tree may additionally comprise one or more secondary user accounts 202 in one or more lower levels 202a, 202b202c.

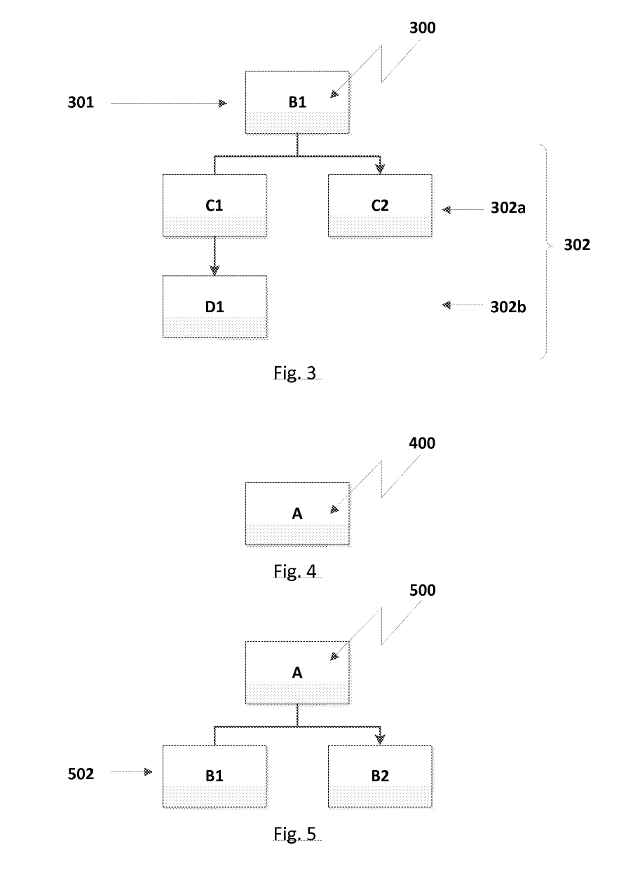

Once a new user account has been created, the user module 101 instructs the referral tree module 102 to create and store a new referral tree for that user account. That user account becomes the primary user account of this referral tree. Therefore, since each user account is the primary account of its own referral tree, each referral tree may comprise a plurality of referral trees. For example, one of the secondary accounts of the referral tree 200 shown in FIG. 2 is labelled B1. FIG. 3 shows the referral tree 300 for which B1 is the primary account 301. Referral tree 300 further comprises secondary user accounts 302 which are arranged in two levels 302a, 302b.

The invitation module 105 is operable to send an invitation to a potential user of the commerce platform 100 at the request of an existing user. These invitations can be sent as an email, a short message service (SMS) message or a message on a social network. The invitation module 105 is further operable to store details of all invitations that it sends, including: an identifier of an existing user who requested that the message be sent, an identifier of a potential new user to whom it was sent and the time at which a request to send the invitation was made. This allows the commerce platform 100 to determine which new users were referred to the commerce platform, by whom and when they were referred.

The user module 101 also checks whether or not any invitations have been sent to the new user by the invitation module 105. If an invitation has been sent, the user module 101 determines a referrer account, being the user account that requested that the invitation be sent. If more there was more than one request that an invitation be sent by the invitation module then the user account which made the first request is taken to be the referrer account. The referral tree module 102 adds the new user account as a secondary user account in all referral trees which comprise the referrer account. The new user account is added to those referral trees at the level directly below the referrer account.

The new user may be given the option of not being added as a secondary user account in all referral trees which comprise the referrer account. If the new user wishes to do this he/she must explicitly opt out and must provide a reason for opting out. If the request by a new user to opt out is granted, the user account that requested that the invitation be sent to that new user may be suspended. This functionality is provided to prevent abuse of the commerce platform 100.

If the user module 101 finds that no invitations have been sent to the new user by the invitation module 105, that new user will not be automatically added as a secondary user account in any referral trees. The commerce platform 100 allows such users to establish a link to another existing user so that that user's account is added as a secondary user account in all referral trees which comprise the existing user's account.

Once a user account has been added as a secondary account on a referral tree, it cannot be removed from that referral tree except in very limited circumstances.

When the referral tree module 102 creates or alters a referral tree, the referral tree module 102 sends a notification message to all user accounts that form part of that referral tree.

The reward module 104 is operable to determine a main award account from one of the user accounts and to distribute at least part of the award value between: said main award account and one or more additional user accounts. Each such additional user account belongs to a reward tree in which the main award account is a secondary user account.

The commerce platform 100 may comprise a plurality of reward accounts and the purchasing module 103 may be operable to distribute the fraction of the purchase value between two or more reward accounts. For example, in one embodiment there are three reward accounts: a main reward account; a mobile reward account; and a special reward account. The distribution of the fraction of the purchase value between these three reward accounts is dependent upon the mechanism that was used to make the purchase. For Web based purchases: 45% of the fraction is allocated to the main reward account; 45% is allocated to the mobile reward account; and 10% is allocated to the special reward account. For Mobile phone based purchases: 20% of the fraction is allocated to the main reward account; 70% is allocated to the mobile reward account; and 10% is allocated to the special reward account.

The reward module 104 determines how and when the award value is distributed. The award value may be distributed: when the award value equals or exceeds a finishing value; when a finishing time is reached; or any other suitable event. Once the reward module 104 has determined a main account and distributed the award value, the reward module 104 may be operable to subsequently determine another main account.

In a first embodiment, the reward module 104 has a predefined start value and a predefined maximum value. A fire value between the start and maximum values is randomly generated. This random generation is chosen to a uniform, flat distribution so that, on average, the fire value will be half way between the seed and maximum value. When the award value reaches the fire value, the reward module 104 determines a main award account. The main award account is the user account that made the purchase that caused the award value to exceed the fire value.

In a second embodiment, the reward module 104 is arranged to determine a main award account once per day and/or once per week.

In a third embodiment, the reward module 104 comprises a predefined starting value and a predetermined time period. When the time period elapses, the reward module 104 randomly chooses a main award account from the subset of all user accounts which have contributed to the award value. The probability that a user account from this subset is chosen is a function of the size of the contribution that that user account made to the award value. In this way a user making larger purchases will have a greater chance of receiving a share of the award value.

In a fourth embodiment, the reward module 104 comprises a predefined starting value and a predetermined event. This event may be a particular outcome of a game or other definable instance. The user account of the user who caused that event to occur is chosen to be the main award account.

The reward module 104 distributes the award value according to a predetermined formula. There may be provision for an administrator of the commerce platform 100 to alter the formula.

In one embodiment, 50% of the award value is transferred to the main award account. The remainder of the award value is shared between those user accounts that share a referral tree with the main award account and are fewer than four levels above the main award account. In particular, 30% of the award value is shared by all user accounts that are one level above the main award account, 15% is shared by all user accounts that are two levels above the main award account; and 5% is shared by all user accounts that are three levels above the main award account. Therefore, for the example referral tree 200 shown in FIG. 2, if user account D1 in level 202c is chosen by the reward module 204 to be the main award account, 50% of the award value is transferred to D1, 30% of the award value is shared by user accounts C, C2 and C3, 15% is shared by all user accounts B1and B2 and 5% is transferred to user account A.

If, as in FIG. 4, the main award account 400 has not been added as a secondary account in any referral trees, and therefore has no higher level user accounts, 40% of the award value is still transferred to the main award account and the remaining 50% of the award value remains in the reward account.

If the main award account does not belong to a referral tree which contains three higher levels, the highest level will receive the entire balance of the award value. For example, if the main award account belongs to a referral tree which contains only one level above the main award account, comprising a single referrer account, the remaining 50% of the award value will be transferred to that referred account. Therefore, for the example referral tree 500 shown in FIG. 5, if user account B1 in level 502 is chosen by the reward module 204 to be the main award account, 50% of the award value is transferred to B1 and the remaining 50% of the award value will be transferred to user account A.

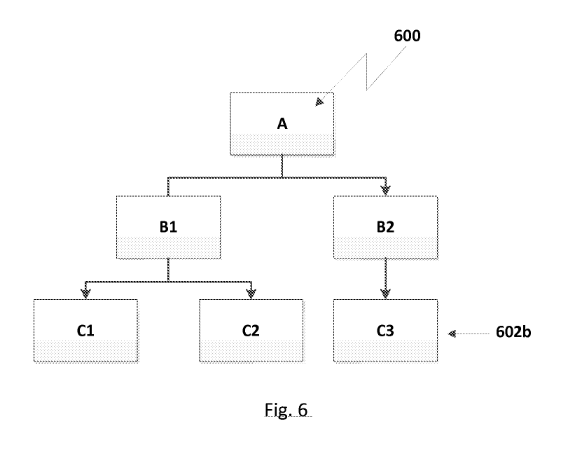

Similarly, if the main award account belongs to a referral tree which contains only two levels above the main award account, 30% of the award value will shared amongst the user accounts on the level above the main award account and the remaining 20% of the award value will be transferred to the single user account two levels above the main award account. Therefore, for the example referral tree 600 shown in FIG. 6, if user account C2 in level 602b is chosen by the reward module 204 to be the main award account, 50% of the award value is transferred to C2, 30% of the award value will shared amongst the user accounts B1 and B2 and the remaining 20% of the award value will be transferred to user account A.

The above embodiments are described by way of example only. Many variations are possible without departing from the scope of the invention as defined in the appended claims.

1. According to a first aspect of the present invention there is provided a commerce platform comprising:
a user module that is operable to create and store a user account for each of a plurality of users of the commerce platform;
a referral tree module that is operable to create and store a plurality of referral trees, wherein each referral tree comprises a primary user account and may additionally comprise one or more secondary user accounts, the referral tree module being operable to: create and store such a user referral tree for each user account, said user account being the primary user account of said the referral tree; and, optionally, to add each user account as a secondary user account of one or more existing referral trees;
a purchasing module that allows each user to purchase one or more items in exchange for a purchase value wherein the purchasing module is further operable, when a user makes such a purchase, to transfer a fraction of the purchase value from that user's user account to a reward account to contribute to an award value; and
a reward module that is operable to determine a main award account from one of the user accounts and to distribute at least part of the award value between: said main award account and one or more additional user accounts wherein each additional user account belongs to a referral tree in which the main award account is a secondary user account.

2. A commerce platform as claimed in claim 1, wherein the secondary accounts of a referral tree correspond to users who have been referred to the commerce platform by the user corresponding to the primary user account of that referral tree.

3. A commerce platform as claimed in claim 1, wherein the award account is determined by selecting a user account from a subset of the user accounts which have contributed to the award value.

4. A commerce platform as claimed in claim 3, wherein the selection of the main award account is weighted so that the probability of a user account being selected as the main award is a function of the value that has been transferred from that user account into the reward account.

5. A commerce platform as claimed in claim 1, wherein the referral trees can comprise one or more levels of user accounts.

6. A commerce platform as claimed in claim 5, wherein the primary user account of a referral tree is the top level of that referral tree and a referral trees can comprise one or more levels of secondary user accounts which are lower than the level of the primary user.

7. A commerce platform as claimed in claim 1, wherein the reward module is operable to distribute the award value so that a first portion is transferred to the main award account and the remainder of the award value is shared between a subset of the additional user accounts.

8. A commerce platform as claimed in claim 7, wherein the subset of additional user accounts comprises those user accounts that are less than a fixed number of levels above the main award account in the referral trees to which they both belong.

9. A commerce platform as claimed in claim 1, further comprising an invitation module that is operable to send an invitation to a potential user of the commerce platform.

10. A commerce platform as claimed in claim 9, wherein the invitation module is further operable to store any or all of the following details relating to invitations that it sends:
an identifier of an existing user who requested that the message be sent; an identifier of a potential new user to whom it was sent; and the time at which a request was made to send the invitation.

11. A commerce platform as claimed in claim 1, wherein when the user module creates a new user account it is operable to instruct the referral tree module to create and store a new referral tree with the new user account being the primary user account for said new referral tree.

12. A commerce platform as claimed in claim 9, wherein when the user module creates a new user account it is operable to check whether or not any invitations have been sent to said user by the invitation module and, if so, further operable to: determine one or more referrer accounts that requested that said invitations be sent; and instruct the referral tree module to add the new user account as a secondary user account of any referral trees which comprise those referrer accounts.

13. A commerce platform as claimed in claim 12, wherein the new user account is added to the referral trees which comprise those referrer accounts at the level directly below said referrer accounts.

14. A commerce platform as claimed in claim 12, wherein the user module is only operable to add the new user account as a secondary user account of all referral trees which comprise a referrer account that made the first request for an invitation to be sent.

15. A commerce platform as claimed in claim 1, wherein the referral tree module allows a first user account to be added as a secondary user account of any referral trees which comprise a second user account upon request by the first user.

16. A commerce platform as claimed in claim 15, wherein the first user account is added to the referral trees which comprise the second user account at the level directly below the second user account.

17. A commerce platform as claimed in claim 1, wherein when the referral tree module creates or alters a referral tree, the referral tree module is operable to send a message to all user accounts that form part of that referral tree.

18. A commerce platform as claimed in claim 1, wherein the fraction of the purchase value that is transferred to the reward account is dependent upon any or all of the following: the item being purchased; the user that is purchasing the item; or the purchase value of the item.

19. A commerce platform as claimed in claim 1, wherein the commerce platform comprises a plurality of reward accounts and wherein the purchasing module is operable to distribute the fraction of the purchase value between two or more reward accounts.

20. A commerce platform as claimed in claim 1, wherein the reward module is operable to determine a main award account when an event occurs and wherein said event comprises any of the following: when the award value equals or exceeds a finishing value; or when a finishing time is reached.
